(19) United States
(12) Patent Application Publication
(10) Pub. No.: US 2010/0266775 A1
(43) Pub. Date: Oct. 21, 2010

(54) Non-Smoking Connector Pipe

(75) Inventor: Steven Penatzer, Avoca, PA (US)

Correspondence Address: MITCHELL A. SMOLOW, 720 HAMPTON ROAD, SHAVERTOWN, PA, 18708, US

(73) Assignee: OLYMPIA CHIMNEY SUPPLY, Scranton, PA (US)

(21) Appl. No.: 12/726,961

(22) Filed: Mar. 18, 2010

Related U.S. Application Data
(60) Provisional application No. 61/170,843, filed on Apr. 20, 2009.

(51) Int. Cl. B05D 3/02; F27B 17/00

(52) U.S. Cl. 427/372.2; 432/18

(57) ABSTRACT

A process for producing a fume free connector pipe is disclosed. The connector pipe is placed in a curing oven at a start temperature, the oven having a convective air CFM and an intake/exhaust air CFM. The oven temperature is increased over an increase time period to a hold temperature and the connector pipe is heated at the hold temperature for a hold time period then removed from the curing oven after a total amount of time, the total amount of time being the increase time period plus the hold time period.

### CROSS REFERENCE TO RELATED APPLICATIONS

This application claims benefit of U.S. Provisional Application No. 61170843 filed Apr. 20, 2009.

### FIELD OF THE INVENTION

This invention relates generally to venting exhaust gasses and in particular, to chimney connector pipe.

### BACKGROUND OF THE INVENTION

Connector pipe for solid fuel burning appliances such as stoves (often referred to as stovepipe) is used to direct smoke and combustion wastes horizontally through an outer wall or into a chimney to the outside environment. A common problem that occurs in connector pipe is that on initial use the outer protective and ornamental coating produces smoke and fumes which are introduced into the ambient environment as the pipe is heated during the transportation of hot combustion gasses.

Known connector pipe is manufactured from cold rolled milled steel and coated with high temperature paint that can withstand temperatures of 1000-1400 degree F. High temperature paints comprise a first resin that allows the paint to dry at room temperature. However, although dry at room temperature, the painted surface is soft and marks easily, producing shipping and installation challenges.

To combat this softness, a second, silicon based resin is used to give the paint its high temperature properties. The silicon based resin will only cure at high temperatures, generally at 300-450 degree F. Once fully cured, the painted surface is hard and resistant to scratching. High temperature curing has not been part of the manufacturing process because up until now, it has been time consuming, high in energy usage, and not cost effective. Final curing is left to occur during the first few uses after installation.

As the silicon based resin is going through its high temperature curing phase it releases large amount of thick black smoke having a pungent, unpleasant odor. When a stove and connector pipe are installed (or existing connector pipe is replaced) the first few firings will produce smoke and fumes for several hours. Most structures will need to be evacuated while the curing process is taking place.

Although powder coatings and baked enamel alternative coatings have been used, they have not proven to be commercially viable due to the considerable manufacturing cost and difficulty in matching the coating color for touch-ups and add-ons during installation.

Accordingly, there is still a continuing need for improved connector pipe designs that will not smoke on initial firing after installation. The present invention fulfills this need and further provides related advantages.

### BRIEF SUMMARY OF THE INVENTION

In order to resolve the smoke, odor and cosmetic issues when connector pipe is installed within a structure, the instant specification describes a process to cost effectively fully cure the high temperature paint during the manufacturing process.

This process eliminates the main issues associated with known connector pipes. The process produces connector pipe in which fumes and smoke at initial firing are eliminated and the painted surface is fully cured during the manufacturing process, thereby producing pipe which is resistant to shipping and installation damage.

The process is economical, having a minimal effect on profit margin and retail price, thereby maintaining commercial viability.

The preferred embodiments use a combination of starting temperature, temperature increase time, holding temperature, temperature hold time, hot circulation air flow rate and exhaust/intake air flow rate to achieve a cost effective, commercially viable complete cure of the protective/ornamental coating.

Other features and advantages of the present invention will be apparent from the following more detailed description of the preferred embodiments.

### DETAILED DESCRIPTION OF THE INVENTION

As required, detailed embodiments of the present invention are disclosed;

however, it is to be understood that the disclosed embodiments are merely exemplary of the invention that may be embodied in various forms. Therefore, specific structural and functional details disclosed are not to be interpreted as limiting, but merely as a basis for the claims and as a representative basis for teaching one skilled in the art to variously employ the present invention.

The process combines heretofore unknown combinations of time, temperature, and airflow to achieve full curing of the protective/ornamental coating during the manufacturing process in an economical, commercially viable manner. Initial calculations were performed utilizing energy costs, labor, and profit margin to determine that the curing process should be less than about 0.15 lbs. per minute in order to maintain commercially viable sale pricing and profit margins.

More specifically, energy costs were calculated by using the oven wattage rating to determine the number of kilowatts required for a given cycle parameters, multiplying the total kilowatts by the utility cost per kilowatt and dividing by the number of connector pipe being heated to determine the energy cost per pipe. Start and hold temperatures were utilized to account for decreases in oven temperatures as the oven door is opened during batch processing.

In a preferred embodiment, a connector pipe is fabricated and a protective/ornamental coating, for example, a silicon resin coating, is applied to the connector pipe in a known manner. A protective/ornamental coating first cure is effectuated at room temperature in standard fashion, typically taking about thirty minutes to about one hour. Following the first cure the connector pipe is placed into a curing oven to start a second curing process.

The curing oven is, for example, a rectangular oven constructed utilizing stainless steel finned strip heaters capable of a 1200 degree F. core temperature. The heaters are positioned about six inches from the bottom of the oven on all non door sides. The heaters are controlled by, for example, a programmable digital controller utilizing a calibrated J style thermocouple.

In a first embodiment, the connector pipe is introduced into the oven for a total heating time of about thirty minutes. The connector pipe is introduced at a start temperature of about 400 degrees F. Over about a fifteen minute to about a seventeen minute period the oven temperature is increased to about 450 degrees F. and then held at this temperature for about thirteen to about fifteen minutes, after which the connector pipe is removed from the oven. During the total heating phase, convective air is circulated within the oven at a flow rate of about 125 CFM and intake/exhaust air introduced/removed at a flow rate of about 75 CFM.

Preferably, the increase phase time is about fifteen minutes and the hold phase time is about fifteen minutes, or the increase phase time is about seventeen minutes and the hold phase time is about thirteen minutes.

In a second embodiment, the connector pipe is introduced into the oven for a total heating time of about twenty-five minutes. The connector pipe is introduced at a start temperature of about 400 degrees F. Over about a fifteen minute period the oven temperature is increased to about 450 degrees F. and then held at this temperature for about ten minutes, after which the connector pipe is removed from the oven. During the total heating phase, convective air is circulated within the oven at a flow rate of about 210 CFM and intake/exhaust air introduced/removed at a flow rate of about 75 CFM.

In a third, most preferred embodiment, the connector pipe is introduced into the oven for a total heating time of about twenty minutes. The connector pipe is introduced at a start temperature of about 350 degrees F. Over about a ten minute to about an eleven minute period the oven temperature is increased to about 415 degrees F. and then held at this temperature for about nine to about ten minutes, after which the connector pipe is removed from the oven. During the total heating phase, convective air is circulated within the oven at a flow rate of about 210 CFM and intake/exhaust air introduced/removed at a flow rate of about 75 CFM.

Preferably, the increase phase time is about eleven minutes and the hold phase time is about nine minutes, or the increase phase time is about ten minutes and the hold phase time is about ten minutes.

The following experiments were conducted to determine a complete connecting pipe cure at energy usage levels that produced a commercially viable production cost and profit margin. All testing was performed using 120 lbs (15-6″ diameter×48″ long 22 gauge mild steel connector pipe) stove pipe. The stove pipe was painted with 1200 degree flat black high temperature silicon resin based paint.

Fifteen connector pipes were arranged in a vertical position in three rows of five on a metal rolling cart. For all tests the curing oven was preheated empty to simulate a production process of the curing oven constantly running for all shifts. Connector pipe from each oven corner and the oven center were sampled through a test firing of hot combustion gases passed through the connector pipe.

Test results produced a curing process comprising a combination of temperature increase and hold, hot circulation (convection) air CFM, and exhaust/intake air CFM which achieved the stated goals. Unexpectedly, it was necessary to use convection currents within the curing oven in order to fully cure the entire length of connector pipe in a timely, commercially viable and cost effective fashion. Also unexpectedly, exhaust/intake air was found to be necessary in order to remove the burned resin and carbon dioxide from the oven. Without the introduction of fresh intake air and the removal of equal amounts of exhaust air the connector pipes would produce faint smoke while transporting hot combustion gasses.

Experiment No. 1: The connector pipe was introduced into the oven for a total heating time of twenty minutes at a start temperature of 250 degrees F. Over a seven minute period the oven temperature was increased to 350 degrees F. and then held at this temperature for thirteen minutes, after which the connector pipe was removed from the oven. An incomplete cure was found on all connector pipes, with the center connector pipe smoking heavily upon test firing.

Experiment No. 2: The connector pipe was introduced into the oven for a total heating time of twenty minutes at a start temperature of 300 degrees F. Over an eight minute period the oven temperature was increased to 375 degrees F. and then held at this temperature for twelve minutes, after which the connector pipe was removed from the oven. An incomplete cure was found on all pipes, with the corner pipes smoking only from the upper one third of the pipe during test firing. The center pipe had evidence of smoke over its entire length during test firing.

Experiment No. 3: The connector pipe was introduced into the oven for a total heating time of thirty minutes at a start temperature of 300 degrees F. Over a nine minute period the oven temperature was increased to 375 degrees F. and then held at this temperature for twenty-one minutes, after which the connector pipe was removed from the oven. An incomplete cure was found on all pipes, with the corner pipes lightly smoking from their upper section during test firing. The center pipe smoked from its upper third during test firing.

Experiment No. 4: The connector pipe was introduced into the oven for a total heating time of thirty minutes at a start temperature of 350 degrees F. Over a ten minute period the oven temperature was increased to 400 degrees F. and then held at this temperature for twenty minutes, after which the connector pipe was removed from the oven. An incomplete cure was found on all pipes, with all sampled pipes smoking from their upper section during test firing. Copious amounts of smoke billowed from the oven door after opening.

Experiment No. 5: The connector pipe was introduced into the oven for a total heating time of forty minutes at a start temperature of 350 degrees F. Over a ten minute period the oven temperature was increased to 400 degrees F. and then held at this temperature for thirty minutes, after which the connector pipe was removed from the oven. All pipes had almost a complete cure, with a light amount of smoke during both the test firing and exiting the oven on oven door opening. A forty minute total time was determined not to be commercially viable for production or cost effectiveness.

Experiment No. 6: The connector pipe was introduced into the oven for a total heating time of thirty minutes at a start temperature of 350 degrees F. Over an eleven minute period the oven temperature was increased to 400 degrees F. and then held at this temperature for nineteen minutes, after which the connector pipe was removed from the oven. During the total heating phase intake/exhaust air was introduced/removed at a flow rate of 50 CFM. Curing was almost complete on all pipes with an equal discharge of smoke from the tops of all sampled connector pipe. Considerably less smoke than that of prior parameter combinations exited the oven door on opening.

Experiment No. 7: The connector pipe was introduced into the oven for a total heating time of thirty minutes at a start temperature of 350 degrees F. Over an eleven minute period the oven temperature was increased to 400 degrees F. and then held at this temperature for nineteen minutes, after which the connector pipe was removed from the oven. During the total heating phase intake/exhaust air was introduced/removed at a flow rate of 75 CFM. Curing was almost complete on all pipes with an equal discharge of smoke from the tops of all sampled connector pipe. Considerably less smoke than that of earlier parameter combinations exited the oven door on opening.

Experiment No. 8: The connector pipe was introduced into the oven for a total heating time of thirty minutes at a start temperature of 400 degrees F. Over a fifteen minute period the oven temperature was increased to 450 degrees F. and then held at this temperature for fifteen minutes, after which the connector pipe was removed from the oven. During the total heating phase intake/exhaust air was introduced/removed at a flow rate of 75 CFM. On test firing, the corner pipes had a complete cure, with a slight amount of smoke discharging from the center pipe. Considerably less smoke exited the oven on door opening than in earlier parameter combinations.

Experiment No. 9: The connector pipe was introduced into the oven for a total heating time of thirty minutes at a start temperature of 400 degrees F. Over a fourteen minute period the oven temperature was increased to 450 degrees F. and then held at this temperature for sixteen minutes, after which the connector pipe was removed from the oven. During the total heating phase intake/exhaust air was introduced/removed at a flow rate of 75 CFM. Upon test firing, the corner connector pipes had a full cure. All center row connector pipes were test fired with four out of five producing smoke for a period of three minutes.

Experiment No. 10: The connector pipe was introduced into the oven for a total heating time of thirty minutes at a start temperature of 400 degrees F. Over a fifteen minute period the oven temperature was increased to 450 degrees F. and then held at this temperature for fifteen minutes, after which the connector pipe was removed from the oven. During the total heating phase, convective air was circulated within the oven at a flow rate of 125 CFM and intake/exhaust air was introduced/removed at a flow rate of 75 CFM. Upon test firing, all corner and center connector pipes had a complete cure.

Experiment No. 11: Experiment No. 10 was repeated, with all connector pipes test fired. All were found to be completely cured.

Experiment No. 12: The connector pipe was introduced into the oven for a total heating time of thirty minutes at a start temperature of 400 degrees F. Over a seventeen minute period the oven temperature was increased to 450 degrees F. and then held at this temperature for thirteen minutes, after which the connector pipe was removed from the oven. During the total heating phase, convective air was circulated within the oven at a flow rate of 125 CFM and intake/exhaust air was introduced/removed at a flow rate of 75 CFM. Upon test firing, all fifteen connector pipes had a complete cure. Total cure time was found to be borderline acceptable for commercially viable production and profit margin.

Experiment No. 13: The connector pipe was introduced into the oven for a total heating time of twenty-five minutes at a start temperature of 400 degrees F. Over a fifteen minute period the oven temperature was increased to 450 degrees F. and then held at this temperature for ten minutes, after which the connector pipe was removed from the oven. During the total heating phase, convective air was circulated within the oven at a flow rate of 210 CFM and intake/exhaust air was introduced/removed at a flow rate of 75 CFM. Upon test firing, all test fired connector pipes had a complete cure.

Experiment No. 14: Experiment No. 13 was repeated with all connector pipes test fired. All were found to be fully cured.

Experiment No. 15: The connector pipe was introduced into the oven for a total heating time of twenty minutes at a start temperature of 350 degrees F. Over an eleven minute period the oven temperature was increased to 415 degrees F. and then held at this temperature for nine minutes, after which the connector pipe was removed from the oven. During the total heating phase, convective air was circulated within the oven at a flow rate of 210 CFM and intake/exhaust air was introduced/removed at a flow rate of 75 CFM. Upon test firing, all fifteen connector pipes had a complete cure.

Experiment No. 16: The connector pipe was introduced into the oven for a total heating time of twenty minutes at a start temperature of 350 degrees F. Over a ten minute period the oven temperature was increased to 415 degrees F. and then held at this temperature for ten minutes, after which the connector pipe was removed from the oven. During the total heating phase, convective air was circulated within the oven at a flow rate of 210 CFM and intake/exhaust air was introduced/removed at a flow rate of 75 CFM. Upon test firing, all fifteen connector pipes had a complete cure.

Experiment No. 17: Experiment No. 16 was repeated with the same results.

Although the present invention has been described in connection with specific examples and embodiments, those skilled in the art will recognize that the present invention is capable of other variations and modifications within its scope. These examples and embodiments are intended as typical of, rather than in any way limiting on, the scope of the present invention as presented in the appended claims.

What is claimed is:

1. A non-smoking connector pipe manufacturing process comprising the steps of:
fabricating a connector pipe;
applying a coating to the connector pipe;
completing a first, room temperature, cure;
placing the connector pipe in a curing oven for a second cure at a start temperature, the oven having a convective air CFM and an intake/exhaust air CFM;
increasing the oven temperature over an increase time period to a hold temperature;
heating the connector pipe at the hold temperature for a hold time period; and
removing the connector pipe from the curing oven after a total heating time, the total heating time consisting of the increase time period plus the hold time period.

2. The process of claim 1 wherein the second cure is about 0.15 lbs. per minute or less.

3. The process of claim 1 wherein the total heating time is about thirty minutes or less.

4. The process of claim 1 wherein the connector pipe is introduced into the oven at a start temperature of about 400 degrees F.; the hold temperature is about 450 degrees F.; the increase time period is about fifteen minutes to about a seventeen minutes; the hold time period is about thirteen to about fifteen minutes; the convective air CFM is about 125 CFM and intake/exhaust air CFM is about 75 CFM.

5. The process of claim 4 wherein the increase time period is about fifteen minutes and the hold time period is about fifteen minutes.

6. The process of claim 4 wherein the increase time period is about seventeen minutes and the hold time period is about thirteen minutes.

7. The process of claim 1 wherein the total heating time is about twenty-five minutes or less.

8. The process of claim 7 wherein the connector pipe is introduced into the oven at a start temperature of about 400 degrees F.; the hold temperature is about 450 degrees F.; the increase time period is about fifteen minutes; the hold time period is about ten minutes; the convective air CFM is about 210 CFM and intake/exhaust air CFM is about 75 CFM.

9. The process of claim 1 wherein the total heating time is about twenty minutes or less.

10. The process of claim 1 wherein the connector pipe is introduced into the oven at a start temperature of about 350 degrees F.; the hold temperature is about 415 degrees F.; the increase time period is about ten minutes to about eleven minutes; the hold time period is about nine to about ten minutes; the convective air CFM is about 210 CFM and intake/exhaust air CFM is about 75 CFM.

11. The process of claim 10 wherein the increase time period is about eleven minutes and the hold time period is about nine minutes.

12. The process of claim 10 wherein the increase time period is about ten minutes and the hold time period is about ten minutes.

13. A non-smoking connector pipe curing process comprising the steps of:
completing a first, room temperature, cure;
placing the connector pipe in a curing oven for a second cure at a start temperature, the oven having a convective air CFM and an intake/exhaust air CFM;
increasing the oven temperature over an increase time period to a hold temperature;
heating the connector pipe at the hold temperature for a hold time period; and
removing the connector pipe from the curing oven after a total amount of time, the total amount of time consisting of the increase time period plus the hold time period.

14. The process of claim 13 wherein the second cure is about 0.15 lbs. per minute or less.

15. The process of claim 13 wherein the total heating time is about thirty minutes or less.

16. The process of claim 13 wherein the connector pipe is introduced into the oven at a start temperature of about 400 degrees F.; the hold temperature is about 450 degrees F.; the increase time period is about fifteen minutes to about a seventeen minutes; the hold time period is about thirteen to about fifteen minutes; the convective air CFM is about 125 CFM and intake/exhaust air CFM is about 75 CFM.

17. The process of claim 16 wherein the increase time period is about fifteen minutes and the hold time period is about fifteen minutes.

18. The process of claim 16 wherein the increase time period is about seventeen minutes and the hold time period is about thirteen minutes.

19. The process of claim 13 wherein the total heating time is about twenty-five minutes or less.

20. The process of claim 19 wherein the connector pipe is introduced into the oven at a start temperature of about 400 degrees F.; the hold temperature is about 450 degrees F.; the increase time period is about fifteen minutes; the hold time period is about ten minutes; the convective air CFM is about 210 CFM and intake/exhaust air CFM is about 75 CFM.

21. The process of claim 13 wherein the total heating time is about twenty minutes or less.

22. The process of claim 13 wherein the connector pipe is introduced into the oven at a start temperature of about 350 degrees F.; the hold temperature is about 415 degrees F.; the increase time period is about ten minutes to about eleven minutes; the hold time period is about nine to about ten minutes; the convective air CFM is about 210 CFM and intake/exhaust air CFM is about 75 CFM.

23. The process of claim 22 wherein the increase time period is about eleven minutes and the hold time period is about nine minutes.

24. The process of claim 22 wherein the increase time period is about ten minutes and the hold time period is about ten minutes.

25. A non-smoking connector pipe cure comprising:
a first, room temperature, cure; and
a second cure comprising
placing the connector pipe in a curing oven at a start temperature, the oven having a convective air CFM and an intake/exhaust air CFM;
increasing the oven temperature over an increase time period to a hold temperature;
heating the connector pipe at the hold temperature for a hold time period; and
removing the connector pipe from the curing oven after a total heating time, the total heating time consisting of the increase time period plus the hold time period.

26. The connector pipe cure of claim 25 wherein the second cure is about 0.15 lbs. per minute or less.

27. The connector pipe cure of claim 25 wherein the connector pipe is introduced into the oven at a start temperature of about 350 degrees F.; the hold temperature is about 415 degrees F.; the increase time period is about ten minutes to about eleven minutes; the hold time period is about nine to about ten minutes; the convective air CFM is about 210 CFM and intake/exhaust air CFM is about 75 CFM.

28. The connector pipe cure of claim 27 wherein the increase time period is about eleven minutes and the hold time period is about nine minutes.

29. The connector pipe cure of claim 27 wherein the increase time period is about ten minutes and the hold time period is about ten minutes.
